(19) United States
(12) Patent Application Publication
(10) Pub. No.: US 2026/0058997 A1
(43) Pub. Date: Feb. 26, 2026

(54) SYSTEMS AND METHODS FOR GENERATION AND CONTROL OF GENERATIVE ARTIFICIAL INTELLIGENCE (AI) APPLICATIONS

(71) Applicant: Paradigm Networks, Inc., Pleasanton, CA (US)

(72) Inventor: Waheed Qureshi, Pleasanton, CA (US)

(21) Appl. No.: 19/306,900

(22) Filed: Aug. 21, 2025

Related U.S. Application Data
(60) Provisional application No. 63/685,389, filed on Aug. 21, 2024.

(51) Int. Cl. H04L 9/40; G06F 16/242

(52) U.S. Cl. CPC H04L 63/20; G06F 16/243; H04L 63/101

(57) ABSTRACT

Systems and methods for management of generative AI. An example method includes intercepting, via a gateway implemented by the system, a client request associated with a tool invocation via a model context protocol (MCP) server, wherein the gateway operates as a proxy server between a plurality of MCP servers and a plurality of agents or consoles utilized by end-users; accessing policy information associated with MCP, the policy information reflecting, at least, an allowlist and a denylist associated with MCP servers and/or tools; implementing the policy information, wherein implementing includes: adjusting the client request to replace an MCP server included in the client request with a different MCP server, or adjusting the client request to update a schema associated with a tool identified in the client request; and forwarding the client request for receipt by an approved MCP server.

### CROSS-REFERENCE TO RELATED APPLICATIONS

This application claims priority to U.S. Prov. Patent App. No. 63/685389 filed Aug. 21, 2024 and titled “SYSTEMS AND METHODS FOR GENERATION AND CONTROL OF GENERATIVE ARTIFICIAL INTELLIGENCE (AI) APPLICATIONS,” the disclosure of which is hereby incorporated herein by reference in its entirety.

### TECHNICAL FIELD

The present application relates to systems and methods for monitoring of artificial intelligence (AI) applications.

### BACKGROUND

Generative artificial intelligence (AI) techniques are increasingly being relied upon for technical and business use cases. For example, a large language model (LLM), which is a type of generative AI, may be used to generate lengthy textual passages. In this example, the textual passages may be responsive to a user prompt such which requests the LLM to generate the text. The textual passages may also be responsive to documents or other information included in the user prompt.

At present, such generative AI techniques require substantial technical knowhow and complexity to utilize. Furthermore, at present generative AI suffers from technical issues, such as hallucination, which complicate its use.

### BRIEF DESCRIPTION OF THE DRAWINGS

FIG. 1 is a block diagram illustrating an example artificial intelligence (AI) guardrail system outputting a user interface associated with implementation of AI policies.

FIG. 2 illustrates detail of the AI guardrail system outputting an enriched query based on use of retrieval augmented generation (RAG) and a policy enforcement engine.

FIG. 3A illustrates detail of the AI guardrail system in communication with model context protocol (MCP) server(s).

FIG. 3B illustrates detail of the AI guardrail system receiving a tool request associated with MCP server(s).

FIG. 3C illustrates detail of the AI guardrail system outputting an analyzed client request based on MCP policy information.

FIG. 4 is a flowchart of an example process for response verification with provenance information.

FIG. 5 is a flowchart of an example process for implementing policies associated with generative AI.

FIG. 6 is a flowchart of an example process for implementing a secure MCP gateway.

FIGS. 7A-7C illustrate example user interfaces.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

This application describes techniques to enable, in some embodiments, a no-code approach to creation, and integration, of generative artificial intelligence (AI) applications. For example, a platform may be used by an end-user of an entity to rapidly development, deploy, and orchestrate a generative AI application. As one example, the generative AI application may reflect an agentic application (e.g., an AI-driven application designed to autonomously perform tasks). Advantageously, the generative AI application may access data stored, or otherwise accessible to, the entity. For example, the entity's data may be processed for use in a retrieval augmented generation (RAG) process. Strict access controls associated with use of the entity's data may be put into place, for example user or role-based access controls may be implemented by the platform. Furthermore, the platform described herein may use one or more disparate techniques to analyze input and/or output of the generative AI application. For example, the platform may determine hallucinations, factuality, bias, toxicity, copyright violations, and so on. In this way, the entity may rapidly roll out the generative AI application for use by employees while ensuring conformance with policies.

Generally, the disclosed technology enables a holistic policy-enforcement platform associated with use of generative AI. At present, use of generative AI carries significant risks to an entity, such as a corporation, with a multitude of users. Some examples of technical complications associated with use of generative AI follow. As will be described in more detail below, the disclosed technology reduces a technical burden associated with incorporating generative AI technologies while providing an easy to operate platform that enables incorporation of current, and future-facing, technologies.

For example, while use of a RAG may enable more accurate responses from a large language model (LLM), each user may have access to disparate chunks of data stored within the RAG. Thus, a first user associated with a first role type may not have access to particular data which is accessible to a second user associated with a second role type. In general, RAG data may be stored in, as an example, a vector database which is separate from databases storing other types of information. As may be appreciated, the first user may provide a query which is determined to map to a subset of the particular data. Ensuring that only specifically authorized information is available per user or per user role introduces technical difficulties. This complicates the roll out of a RAG and requires substantial know-how and bespoke customization.

Additionally, as new technologies are introduced, such as the model context protocol (MCP), an entity is required to analyze and create custom back-end workflows/protocols for their implementation. As known by those skilled in the art, and as an example, MCP defines a structured way for an agent client to discover tools exposed by MCP server(s). Examples of tools include functionality to search and read files, list and retrieve objects from storage, query and update databases, perform web search and HTTP fetches, automate browser interactions, post and retrieve messages in collaboration systems, create and update customer-record data, find calendar availability and create events, open and comment on tickets, read and diff source code, geocode addresses and compute directions, perform vector similarity search, and generate or transform documents. MCP thus expands the functionality which an LLM can perform, for example via invoking tools at appropriate times to effectuate requests. Although MCP standardizes tool discovery and invocation, it leaves to the integrator the problems of authorization, data minimization, schema version control, error handling, and auditing across heterogeneous servers.

As a result, safe enterprise adoption of MCP is technically complex. For example, at present tool catalogs are not curated per user role so that only specific, approved, tools are available. Furthermore, at present information included in requests are not analyzed to determine whether sensitive information is included. As may be appreciated, since an MCP tool request may be provided to an external, or not entirely trusted, MCP server, there is a technical avenue for leaking of sensitive information. These, and other factors, introduce technical burdens associated with rolling out, or otherwise incorporating MCP functionality. As new technologies are created, they each require custom workflows and deep technical analyses.

Generative AI is prone to hallucinations or outputting non-factual or accurate information. For many entities, this introduces significant technical risk for their use. Indeed, an entity associated with managing virtual resources (e.g., virtual machines) may leverage an LLM to monitor the resources, and, in substantially real-time, address problems with them. As one example, an entity may use an LLM to identify that a virtual data source is not connecting properly to a virtual machine. For this example, a configuration, or other, issue may be analyzed by the LLM. Accuracy in diagnosis of the issue may be paramount. As part of this, and as described above, a RAG may be used by to surface specific documentation that informs the output of the LLM. However, hallucinations or inaccurate output may be fatal, or complicate diagnosing the above-described virtual resource issue.

With respect to LLMs, at present use of LLMs are typically associated with consumption of tokens. Certain LLMs may use more tokens than others, for example those implementing complex chain-of-thought. As agents are increasingly rolled out for autonomous or semi-autonomous use, each agent may perform actions to effectuate a goal or task and thus consume arbitrary quantities of tokens. This can complicate the tracking of use of tokens, such that an entity may be surprised regarding the consumption of tokens by individual agents or by human users. Thus, at present there is a lack of daylight into use of LLMs across a large entity.

The disclosed technology, as will be described, includes a holistic platform to address at least the above-described problems. Succinct user interfaces may be leveraged to implement cohesive policies that enable rolling out modern generative AI technologies to users of an entity. Additionally, agents may be utilized while ensuring that policies, safeguards, and so on, are maintained for these agents.

In some embodiments, the disclosed technology, which also referred to herein as a platform, may be implemented by a system of one or more computers. For example, the platform may be implemented on-premises of an entity (e.g., the platform may be executed by a system controlled, or otherwise associated with, the entity). As another example, the platform may be implemented in a private or public cloud. For this example, the platform may be associated with different entities (e.g., a multitenant cloud). The platform may, in some embodiments, represent a gateway or proxy through which requests from agents, users leveraging LLMs, and so on are routed.

As will be described, the disclosed technology may provide a unified governance layer that applies consistent policy to inputs, retrieval, tool invocation, and outputs of generative AI systems. The platform establishes, in some embodiments, an enforcement boundary (e.g., a single boundary) through which agent interactions are discovered and executed, and within which identity is bound to each request, schemas are validated, arguments are reduced to least-privilege fields, and results are verified before release. By moving authorization, data-loss prevention, and audit lineage into the execution path, the platform improves computer security and reliability in a way that is rooted in system architecture rather than business rules. For example, requests that would otherwise transmit sensitive values to untrusted endpoints are intercepted and either redacted or refused locally, and requests that would call unapproved services are blocked or substituted with approved equivalents, thereby preventing exfiltration while maintaining functional correctness.

In some embodiments, the platform enforces secure RAG by constraining access at the retrieval source so that only chunks authorized for the requesting principal are eligible for search, ranking, and prompt construction. In some embodiments, the platform governs MCP interactions by acting as a proxy that curates tool catalogs at planning time and re-authorizes and validates each tool invocation at execution time, including optional adaptation through virtual tools that present enterprise-stable schemas while routing to approved backends.

Outputs from generative AI, such as an LLM, may be verified against retrieved sources. For example, outputs may include, or be associated with, provenance information, confidence information, and so on. As an example, provenance information may reflect portions of documents that are relevant to the query and output. Thus, a user, or other LLM, may analyze the documents to ascertain whether the output includes a hallucination or inaccurate information. As another example, confidence may reflect a confidence, or score, associated with an accuracy of the output.

The disclosed technology may additionally determine confidential, or otherwise prohibited information, and take appropriate action. For example, the platform may block malicious prompts from being executed. As another example, the platform may identify personally identifiable information (PII) and remove it, or adjust it, from a prompt. Similarly, the platform may block certain tool accesses, or adjust the request to an MCP server, based inclusion of confidential or otherwise prohibited information.

In some embodiments, token and/or call quotas may be applied per user, agent, project, or tenant. Enforcement decisions may incorporate quota states so that resource consumption is bounded and predictable across heterogeneous models and tools. In some embodiments, a browser-resident component extends the same, or similar, controls to web-based interfaces by mediating prompts and results and by reporting usage for compliance even when users interact through third-party sites.

The foregoing features yield concrete improvements in computer functionality. Authorization and data minimization occur before network egress, which reduces attack surface and prevents time-of-check versus time-of-use errors. Schema validation and argument shaping lower failure rates and unnecessary compute by ensuring only well-typed, policy-compliant payloads reach backends. Deterministic evaluation order and tamper-evident lineage make outcomes reproducible and auditable across runs and environments. Because these effects arise from the claimed system's technical arrangement of identity binding, schema processing, inline redaction, protocol mediation, and resource governance, they improve the operation of computer systems that host, connect, and execute generative AI workloads, rather than merely organizing human activity.

An agent, in some embodiments, may reflect a software component that, upon receiving an input describing a goal, task, or user request, selects and performs one or more actions without, or with limited, step-by-step human direction for each action. In some embodiments, an agent produces an action plan, invokes external tools or services, consults data sources, and generates an output that advances or completes the goal. An agent may employ an LLM, a deterministic program, a rules engine, a planner, or any combination thereof. An agent may maintain state such as working memory or long-term memory, or may operate statelessly. An agent may run on a client device, within a browser, inside an integrated development environment, on a server, or in a containerized service, and may operate alone or as a coordinator of sub-agents.

### Example Block Diagrams

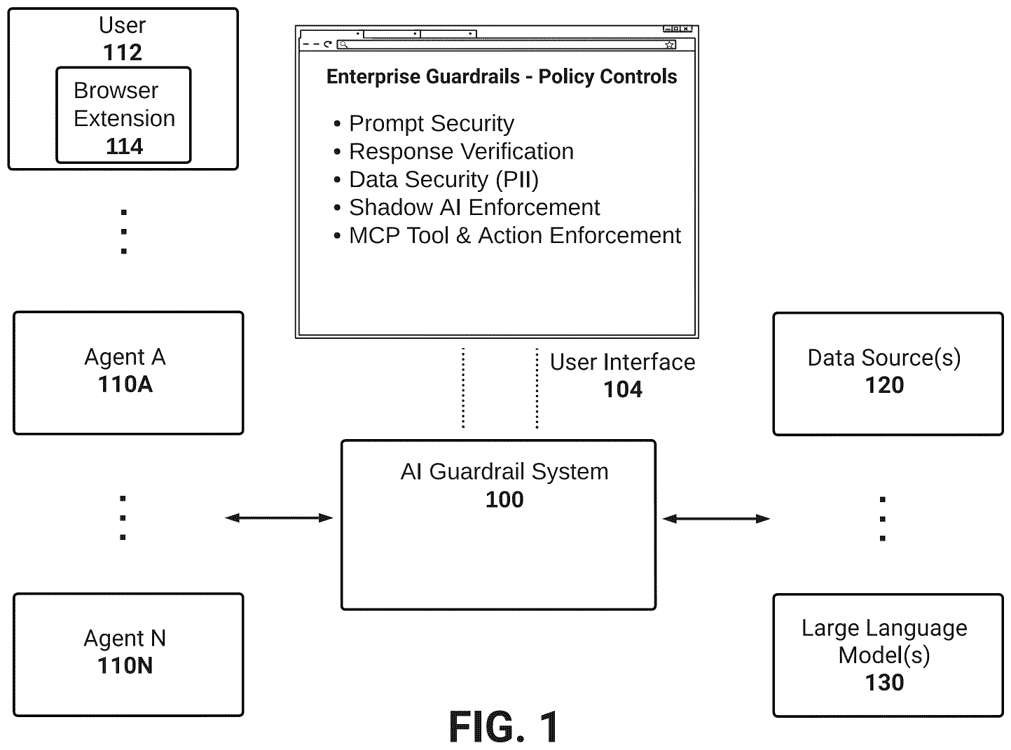

FIG. 1 is a block diagram illustrating an example artificial intelligence (AI) guardrail system 100 outputting a user interface associated with implementation of AI policies. The AI guardrail system 100 may represent, as described herein, an on-premised system or a system hosted in a cloud (e.g., a private or public cloud). The system 100 may represent software executed by an on-premises system or cloud. The system 100 may act as a gateway between agents or users and generative AI technologies. Thus, in some embodiments all requests from an agent or a user, such as via an application or console, may be routed through the system 100 for analysis. The system 100 may then adjust a request, discard the request, reject the request along with explanatory information, and so on.

As described herein, the AI guardrail system 100 may implement generative AI policies across the extent of generative AI usage. For example, generative AI policies may relate to prompt security (e.g., detection of prompt-injection and enforcement of input constraints). Policies may further relate to response verification and provenance (e.g., blocking unsupported or non-factual content). Policies may further relate to data security and confidentiality (e.g., identification and redaction of personally identifiable information (PII), protected health information (PHI), confidential information. Policies may further relate to shadow-AI enforcement (e.g., governing interactions with third-party web-based model interfaces). Policies may further relate to Model Context Protocol (MCP) tool and action governance (e.g., including curated discovery, allow/deny lists, schema validation, and least-privilege shaping prior to tool execution).

In the illustrated example, a user interface 104 may be used by a user of an entity to define and cause enforcement of the example policies. For example, the user interface 104 may be interactive and enable workflows to define techniques by which the AI guardrail system 100 is to ensure prompt security, response verification, data security, shadow AI enforcement, and MCP tool enforcement.

In some embodiments, the policies described herein may be defined through user interface 104 which may present a catalog of policy objects or templates. These may indicate, for example, one or more of scope, modality, conditions, and actions. Scope, as an example, may bind the policy to one or more principals (e.g., users, groups, applications, agents) and resources (e.g., data sources 120, LLMs 130, or specific MCP tools), with precedence rules that allow global, project, and application levels and deterministic tie-breaking. Modality, as an example, may designate the stage governed by the policy (e.g., prompt security, response verification, data protection, shadow-AI/browser enforcement, or MCP tool/action governance as depicted in FIG. 1). The user interface 104 may expose a tailored editor for each. Conditions, as an example, may be expressed as structured fields or text. Example conditions may include examples include matchers over request metadata (e.g., role, project, network), content classifiers (e.g., PII/PHI/IP categories, source-code detection), and model/tool attributes (e.g., model name, temperature range, tool name/version). Actions, as an example, may declare what the AI guardrail system 100 will do when a condition is met, including block, allow, redact/tokenize, substitute (e.g., rewrite to an approved virtual tool), throttle, require human-in-the-loop, or attach provenance requirements. Thresholds (e.g., toxicity≥T, hallucination score>H) and limits (token quotas) may additionally be defined the using the user interface 104.

In some embodiments, the interface 104 provides a policy-authoring workflow with validation, simulation, and staged rollout. When a user drafts a policy, the user interface compiles the specification into a normalized intermediate form and performs static checks (e.g., schema correctness for MCP tool arguments, circular-reference detection in policy inheritance, conflict checks against existing rules). A simulation pane accepts exemplar prompts, MCP calls, or retrieval queries and shows the exact evaluation trace (e.g., ordered rules, matched conditions, redactions applied, substitutions performed) and the resulting disposition (allow/deny/modify) before the policy is published. Publishing creates a new, immutable policy version with effective-time metadata; operators can roll out to canary principals, monitor effects, and promote to wider scopes, with one-click rollback to any prior version. The AI guardrail system 100 ingests published versions over a signed control channel and enforces them inline for interactions with agents 110A-110N, data sources 120, and LLMs 130, ensuring that the same authored rules produce identical runtime behavior across deployments.

The AI guardrail system 100 may be in communication with a multitude of agents 110A-110N. As described herein, an agent may be substantially autonomous that it performs actions according to goals, workflows, and so on. The agent may leverage, as one example, a large language model (LLM) to perform disparate tasks (e.g., large language models (LLMs) 130). The AI guardrail system 100 may additionally be in communication with user clients, such as users'communication with LLMs 130 via web interfaces, local applications, and so on. The system 100 may access data sources 120 associated with an entity, which may include database information, unstructured information, information which has been converted into a form for use with retrieval augmented generation (RAG) (e.g., a vector database, such as chunks of information converted into vectors).

The system 100, which is also referred to herein as a platform, may additionally provide example generative AI applications. For example, a chatbot application may be provided which may use any large language model (LLM) or large multimodal model (LMM). As another example, a search application may be provided with policy controls which uses an LLM or LMM (collectively hereinafter, an LLM). Advantageously, policy constraints or controls may be used to ensure that the generative AI applications are used in conformance with a policy, or set of policies, associated with an entity. The generative AI applications may provide information to an external system, such as one implementing a generative AI application (e.g., an LLM) such as OpenAI, Anthropic, and so on.

The platform may enable a no code tool to build a generative AI application. In some embodiments, the tool that may reduce an extent to which coding is required. For example, the generative AI application may be built based on existing templates or functionality. As one example, the platform may provide front-end user interfaces associated with designing, or otherwise assigning, functionality for the generative AI application. In some embodiments, the generative AI application may be built based on selections of, or identifications of, AI-based tasks which form the application. As another example, the generative AI application may be built using an application programming interface (API) associated with the platform.

As described above, the platform may integrate with data associated with the entity (e.g., data sources 120). For example, the entity's data may be processed using a RAG process (e.g., the data may be stored in one or more vector databases). In this example, the platform may integrate with the entity's data via cloud storage applications or via integrations with storage systems of the entity. The platform may additionally integrate with identity provider(s) (IdP) associated with the entity, to manage end-users'digital identities. IdP may be used, as an example, for access controls with respect to accessing data, generative AI applications, LLMs, and so on. The platform may additionally integrate with security information and event management (SIEM) technology, security operations center platform, and so on.

As will be described, the input and output to the generative AI applications, such as to an LLM, may be controlled. For example, the input and/or output may be analyzed to detect hallucinations, bias, toxicity, copyright issues, and whether the input and/or output is factual. Thus, an entity may trust that the generative AI applications are generating useful, and safe, output for use by end-users of the entity.

The platform may include example generative AI applications although arbitrary other applications may be effectuated by, or have information routed through, the system 100. These applications may include, for example, one or more of an agentic application developed using the platform, a chatbot, and an enterprise search application. Advantageously, controls may be implemented to limit, or exclude, types of data, including protected health information, personally identifiable information, and so on. The data may be processed using a RAG technique, such that input prompts from end-users may leverage the data. For example, the input prompts may be enriched based on the data. As described herein, the input prompt may have policy controls or constraints. For example, the input prompt may be analyzed to detect personally identifiable information. As another example, the input prompt may be analyzed for jail breaks or other adversarial content (e.g., prompt injection techniques). The input prompt may additionally be analyzed for toxicity, bias, and so on.

Thus, the platform may enrich input prompts while ensuring policy controls are enforced. The input prompt, such as a sanitized version (e.g., the illustrated sanitized input) may then be provided to an external, or internally executed, generative AI application (e.g., an LLM). The output may similarly be analyzed using policy controls, such as to evaluate for factuality, hallucination, bias, toxicity, copyright, and so on. Additionally, the output may be analyzed to detect personally identifiable information, protected health information, source code, or other arbitrary policy controls defined by the entity.

In some embodiments, the platform may receive a prompt from an end-user associated with an entity. The prompt may be associated with a generative AI application, such as one developed using the platform or one leveraging an LLM application. The platform may enrich the prompt based on context determined using a RAG process. For example, data associated with the entity (e.g., data stored by or otherwise accessible to the entity) may be provided in the prompt. The prompt may be analyzed using disparate policy controls. Additionally, access to the data and/or the generative AI application may be constrained based on user or role-based access controls. Output from generative AI application may be analyzed using disparate policy controls. For example, the output may be analyzed to detect hallucinations or not factual responses. In some embodiments, multiple generative AI applications (e.g., multiple LLMs) may be used. Output from the multiple generative AI applications may be analyzed, for example to determine hallucinations. The platform may select one of the outputs for response to the end-user.

In some embodiments, the system 100 may implement an example process associated with orchestration. As described herein, the platform may be installed on-premises, in a data center, or in a public cloud, and the system persists, for each user and application, records of policies and interactions for observability during operation. Policy controls are defined during system setup. The system integrates with identity providers to bind principals and integrates with language models for inference. The system integrates with enterprise data sources to create data pipelines for retrieval-augmented generation and, in some configurations, for fine-tuning; user or group associations can be mapped to specific data holdings. Retrieved text is embedded and stored in a vector database, and retrieval may be performed selectively over files, directories, or larger repositories so that agentic applications can be built on subsets of the corpus. Application flows can be created and, when desired, stitched together without code. Before inference, a prompt can be enriched with authorized retrieval results and, when specified, with results from the public Internet that are tagged with source metadata for explainability. The enriched prompt is dispatched to a policy enforcement stage, after which the prompt is post-processed under applicable policies and transmitted to the language model. The model's output is then evaluated under policy (including verification checks), and a verified output is returned to the user. An observability interface surfaces usage and enforcement information produced by these stages.

In some embodiments, the system 100 may be used to manage policy controls associated with an entity. For example, front end user interfaces, such as user interface 104, may be presented via the platform. In this example, the platform may be associated with a web application which is accessible to end-users of an entity. The web application may be used, at least in part, to manage the policy controls. For example, user and application management controls may be used. In this example, the platform may integrate with an IdP and apply policies to user or application controls. As another example, the policy orchestrator may manage data source connectors, role-based access controls (e.g., for RAG or other aspects of the platform), and so on. The policies may be ingested from external sources, for example the platform may ingest textual descriptions, or software-based descriptions, of the policy controls. The policy controls may additionally be specified using the above-described front end user interface.

In some embodiments, the platform includes an observability service configured to persist and surface records of usage, policy evaluation, and application lifecycle events so that operation of generative AI applications is reviewable and auditable. The service maintains dashboards organized by project or application that expose end-to-end lifecycle information, including who authored or modified artifacts and when, how the application was initially evaluated, and accumulated token usage metrics attributable to model/API calls; a project-scoped view supports audits and compliance reviews. The observability service further records comprehensive prompt interaction data across users and agentic applications, including the prompts issued, any enterprise data selected for enrichment, detected policy violations, success or failure outcomes under applied policies, and measured response times. In some implementations, the service ingests policy-enforcement events emitted by other components and aggregates them by principal and project, capturing for each prompt the policies applied, violation statistics (including blocks, redactions, and anonymizations), model availability signals, and usage patterns from which new policies may be derived. The service also maintains data lineage and application-lifecycle logs indicating, for each agentic application, who created it, what data sources it used, to whom it was published, and changes made over its lifetime, thereby providing a durable record suitable for audit and governance.

In some embodiments, the platform includes a generative-AI risk controls service configured to evaluate model outputs and enforce policy at run time. The service computes per-dimension scores for factuality, hallucination, toxicity, and bias, and in certain implementations synthesizes those measurements into a holistic accuracy signal whose outcomes include “accurate,” “inaccurate,” or “cannot determine→human-in-the-loop. ” Hallucination may be determined using both LLM-based and non-LLM methods, with the specific technique selected at runtime according to prompt classification and context; factuality may be assessed using an LLM and/or external search or another source of truth. In parallel, the platform enforces policy controls over model access and prompt enrichment, including access control rules scoped to users, groups, and organizations obtained from an identity provider. The platform further evaluates prompts for prompt-injection and adversarial content using a layered detector that combines rigorous input validation (including allowlists and denylists), pattern matching with regular expressions, semantic analysis for inconsistencies, and machine-learning models trained on known adversarial prompt patterns; the detector also incorporates continuous monitoring to flag unusual or previously unseen prompts, and may invoke a human-in-the-loop when an unknown prompt is encountered. Where applicable, the service determines copyright or source lineage for outputs using LLM-driven and web-assisted techniques so that provenance is available for downstream policy decisions.

The platform may implement controls for risks associated with development and/or usage of generative AI applications. The platform may analyze output from the applications, such as from an LLM, to evaluate factuality, hallucination, toxicity, bias, and so on. In some embodiments, individual scores may be generated (e.g., a hallucination score may be generated which is indicative of the likelihood of hallucination in an output). In some embodiments, a holistic accuracy signal or score may be generated. Additionally, controls may include policy controls such as access controls for applications based on IdP users, groups, organizations, and so on. Policies can be created for access controls for prompt enrichment. The controls may include evaluating prompts for prompt injection/adversarial prompts. The platform may use a combination of one or more of whitelists, blacklists, pattern matching, semantic analysis, machine learning models trained on adversarial prompt input, detection of unusual prompts, and so on.

In some embodiments, the system 100 may analyze responses from LLMs 130 for intellectual property violations (e.g., copyright issues). For example, the platform may receive output to be verified. The platform may break the output into discrete portions. In some embodiments, weights may be assigned to words included in a discrete portion with more common words receiving lower weights. The platform may then compare the discrete portion with external sources, such as via similarity scoring techniques, to detect potential similarities with existing text. While test is described, as may be appreciated other modal output may be analyzed (e.g., images, audio, video, and so on).

As one example of a copyright check, such that when a copyright-check policy is enabled, the system 100 may sends the model output (OP) to a verification component, performs text processing to produce a normalized variant (OP*), and segments OP* into equal-sized paragraphs or other groups of words for comparison. The system then searches information sources and the public Internet for each segment, identifies any matches, and accumulates a matched-link set; if the set is empty the OP is treated as unique, and if not empty the platform applies policy to determine whether to display the content only with cited sources, to warn, or to withhold the content from the user. During preparation, the component extracts words from the OP, identifies and weights common words or grammatical symbols, and removes empty characters and unnecessary whitespace; grouping and comparison employ hash-based matching and specialized indexed comparisons to expedite search; candidate URLs are retrieved and filtered for authority and relevance; and the system generates a content-verification report listing matched spans, identified sources, and an assessment that considers fair-use or applicable terms.

In some embodiments, the platform provides selectable techniques to evaluate dimensions such as factuality, hallucination, bias, and toxicity of model outputs. Each dimension may be computed by one of several algorithms, with the selection made at run time according to factors such as the category of the prompt, the model in use, latency and token constraints, and required confidence. For factuality, an implementation may supply the original prompt and its associated context to a verifier and compare the verifier's response to the candidate output to yield a numerical score in a defined range (e.g., 0-100); in certain implementations the verifier additionally consults external sources of information designated by policy. For hallucination, an implementation may employ a first technique that uses a language model to test internal consistency and a second, non-LLM technique that compares salient claims against available context, with the platform selecting between the techniques per request. Bias detection may return a bounded score and an associated label for interpretability (for example, “No Bias” for scores in a lower range and “Biased” for scores in an upper range). Toxicity detection may likewise produce a bounded score with labeled ranges and may classify specific categories of harmful content. In some embodiments, the platform synthesizes the per-dimension measurements into a holistic accuracy signal whose outcomes include, by way of example, “accurate,” “inaccurate,” or “cannot determine,” the latter optionally invoking a human-in-the-loop review.

In some embodiments, thresholds are established for one or more of the foregoing scores, and policy actions are applied when a threshold is not met. As non-limiting examples, the platform may withhold or redact an output when a toxicity score exceeds a configured level; require human review when the holistic accuracy signal indicates “cannot determine”; re-run verification for factuality using a stronger technique; route the request to a different generative model configured for the use case; or adjust and resubmit the input prompt by adding authorized context via retrieval-augmented generation or by decomposing the task into sub-prompts. Thresholds and actions may be specified per application, user role, or data classification, and may be updated without code changes so that an entity can customize which techniques are applied and how their results affect release of outputs.

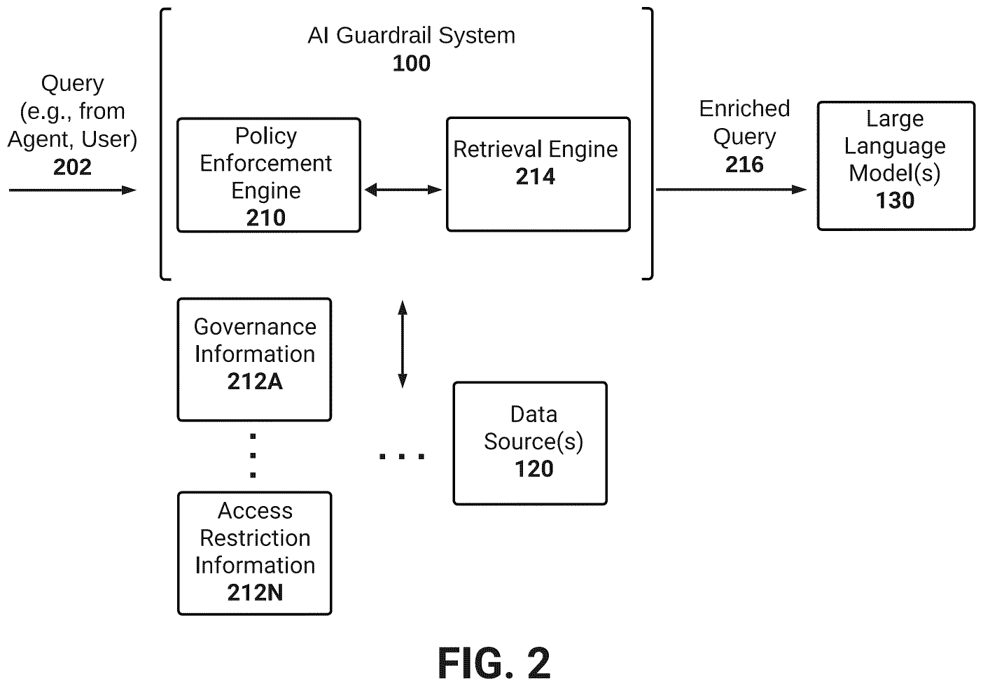

FIG. 2 illustrates detail of the AI guardrail system 100 outputting an enriched query 216 based on use of retrieval augmented generation (RAG) and a policy enforcement engine 210. As described herein, the system 100 may ensure that information included in a prompt, for example to enrich a query 202, may satisfy policies associated with data use. The query 202 may be received from an agent, a user (e.g., using a web application or application associated with a generative AI technology, such as an LLM), and so on.

Prior techniques leveraged RAGs to surface chunks or portions of data (e.g., text) that are relevant to a query. For example, documents or information may be stored in databases. In this example, portions of the documents or information may be converted into vectors and, at inference time, the user's query may be used to surface certain of these vectors. The resulting query may be updated to include portions of the documents or information such that an LLM is able to more accurately respond to the query.

As described above, data may be subject to strict policies regarding access rights. For example, role-based access controls (RBAC) may be used. As another example, access control lists (ACLs) may be used. At present there is no scheme by which an entity can ensure that all data incorporated into a query, such as via a RAG, will satisfy these, and other, access rights.

The AI guardrail system 100 may include a policy enforcement engine 210 to enforce disparate policies associated with enriching queries. For example, the policy enforcement engine 210 may evaluate a query 202 and any candidate retrieval results before the query is enriched and transmitted to a large language model. In operation, the engine 210 associates the query 202 with a principal that can include a user identifier, a group or role, and an application or agent context. The engine 210 may then consult, or otherwise access, example stores of policy data, which may be defined by an entity for example leveraging the user interface of FIG. 1, via an API associated with the system 100, or via documentation ingested by the system 100.

Access restriction information 212N encodes entitlements and is used to determine whether a particular user or agent is permitted to access specific data items. Governance information 212A encodes non-entitlement controls that condition how eligible data may be used in enrichment, including redaction rules, prompt-security checks, provenance requirements, and model or token constraints. In some embodiments, the engine 210 may apply these stores, in some embodiments, in an order so outcomes are repeatable. For example, entitlements from 212N may be evaluated first to remove ineligible material. Governance controls from 212A may be applied to the remaining material to shape content to least privilege before formation of the enriched query 216.

In some embodiments, access restriction information 212N describes fine-grained permissions over the data sources 120. The information can bind users and groups to resources such as repositories, folders, documents, database tables, and fields, and can incorporate row-level or attribute-level constraints, time-bounded grants, and environment tags such as production or staging. During indexing, each chunk or passage written to a retrieval store is annotated with identifiers that reference the applicable entries in 212N so that the retrieval engine 214 can constrain candidates at search time. At inference, the retrieval engine 214 executes a similarity search that returns a candidate set together with the attached access tags. The policy enforcement engine 210 intersects the candidate set with the entitlements resolved for the principal and drops any passage that is not permitted. As one example, a user in a finance role may query a corpus that contains both public policy manuals and restricted payroll extracts; passages derived from the payroll extracts are excluded because the principal's entry in 212N does not authorize that collection. As another example, a legal hold associated with a project can be represented in 212N as a deny rule that withdraws a set of documents from retrieval for all principals until the hold is lifted. Thus, the information 212 may relate to, as some examples, role-based access controls, access control lists, but may additionally be fine-grained.

In some embodiments, governance information 212A governs how authorized portions of information or documents are prepared for enrichment and how the resulting enriched query 216 is constructed. The information can specify schema and format requirements for passages, content filters for sensitive categories such as personally identifiable information, protected health information, secrets, and source code, prompt-security checks for adversarial content, provenance and citation requirements, budget limits, and model selection or parameter ranges. The policy enforcement engine 210 applies the controls from 212A to each authorized passage and to the caller-supplied portion of the query 202. Sensitive values that match configured detectors can be masked or replaced with vault-backed tokens whose re-hydration is permitted only for designated sinks. Free-form fields are evaluated for instruction-injection risk using rules and, in some implementations, a classifier, and passages that exceed configured thresholds are withheld from enrichment. Where governance requires provenance, the engine 210 attaches source identifiers for each retained passage so that the large language model can be instructed to cite or prefer those sources. The engine 210 then assembles the enriched query 216 from the caller text and the approved passages, trimmed to least-privilege content and constrained to the formats and budgets specified in 212A.

In some embodiments, retrieval is constrained to the same access controls that govern the underlying source data. At ingest, each document is evaluated against classification policy; items marked confidential, secret, or intellectual property can be excluded from embedding entirely, or embedded with metadata that encodes their entitlements. The metadata binds each vector to the document's access rules, including role-based access control and access-control list entries, so that an embedding cannot be retrieved in a context where the corresponding document would not be readable.

At query time, the system 100 may bind the query 202 to a principal (e.g., user or other entity) and determine entitlements. For example, a particular user may have access to a subset of files or portions of files. In this example, the system 100 may determine these access rights at the outset. The retrieval engine 214 may then form a filtered view of the embedding store that includes vectors whose attached permissions intersect with those entitlements. Similarity search may be executed against this filtered view rather than the entire index, and the enriched query is constructed solely from passages admitted by that filter. In some embodiments, the filter is produced by traversing an authorization graph that links principals to groups and groups to resources, yielding the set of document and vector identifiers eligible for the user. The result is a secure RAG process that first determines which files the user may access and then limits retrieval and prompt enrichment to that subset, ensuring that no content outside the user's permissions can influence model outputs.

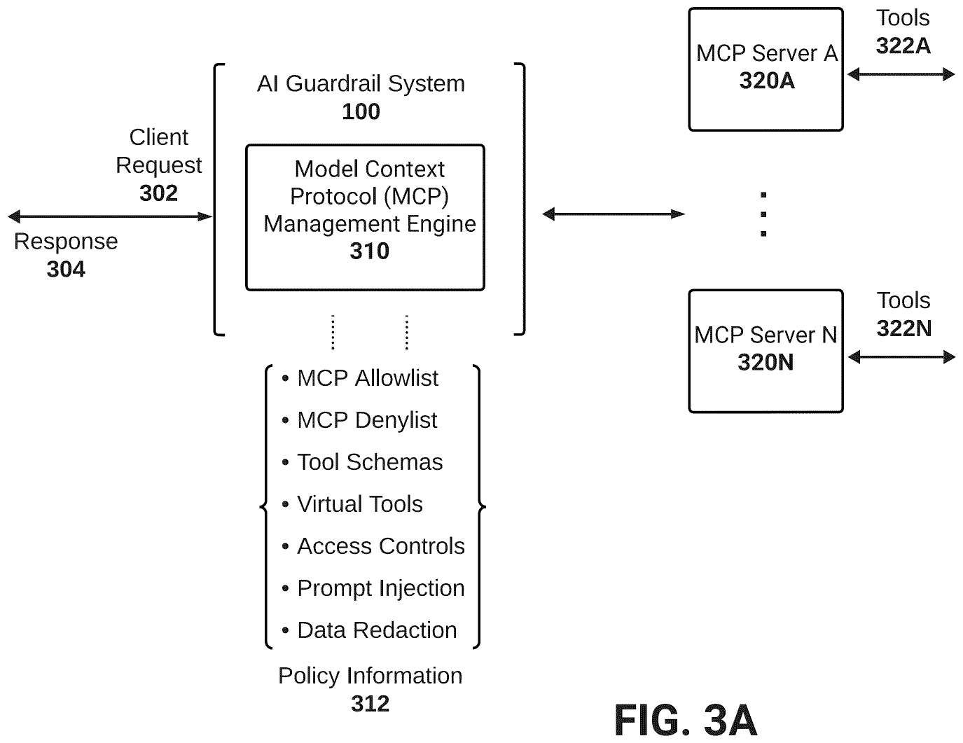

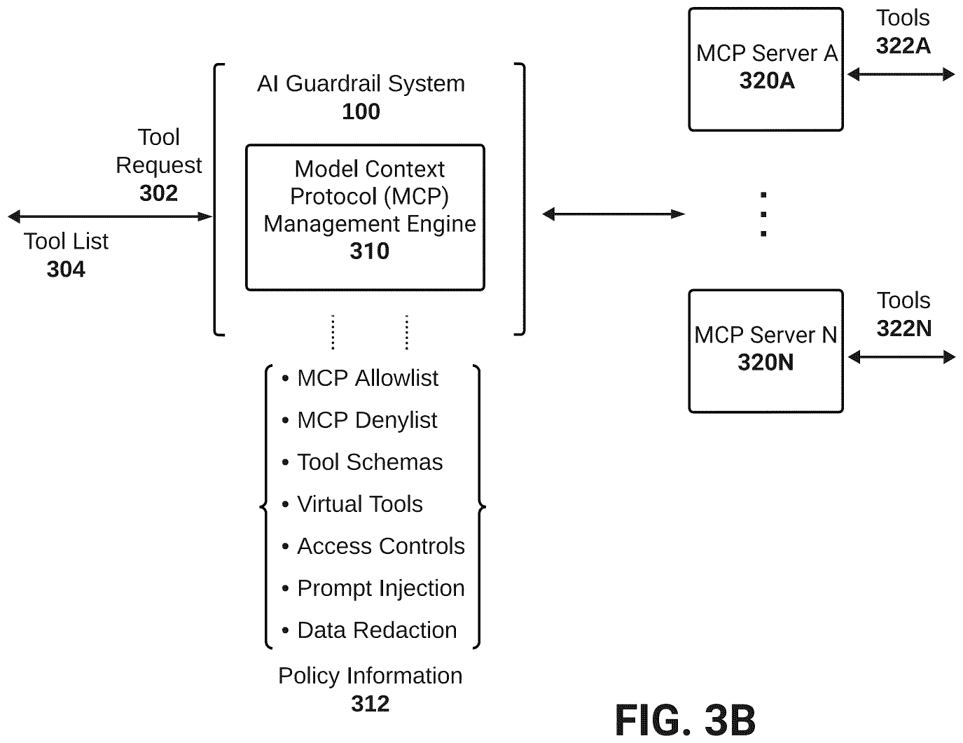

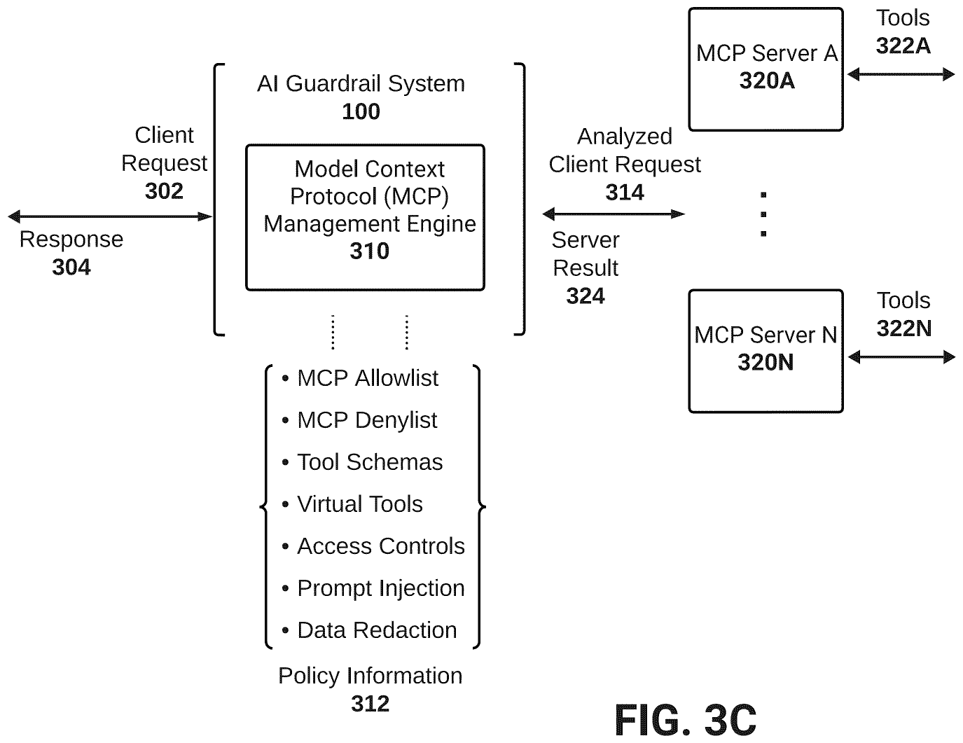

FIG. 3A illustrates detail of the AI guardrail system 100 in communication with model context protocol (MCP) server(s) 320A-320N. As described above, MCP may be used to provide added functionality to an agent or user leveraging a generative AI model (e.g., an LLM). For example, MCP may enable use of specific tools 322A-322NN which are associated with the MCP server(s).

While MCP is an important emerging technology, at present there is no policy enforcement mechanism to ensure guardrail usage of the technology. For example, certain tools may be technically risky or dangerous to use. Thus, at present, an agent may invoke an MCP server even if it is untrusted or unauthorized. Furthermore, sensitive data may be transmitted to tools, or surfaced via tools, without policies like filtering, redaction, or access controls.

To add governance and secure policies, the AI guardrail system 100 includes an MCP management engine 310. As described above, the system 100 may reflect a gateway through which requests flow. Thus, the system 100 may receive a client request 302 from an agent or client associated with a user. For example, the AI guardrail system 100 may operate as a terminating proxy for MCP traffic so that discovery and execution of MCP tools traverse a governed boundary.

A client request 302 may be received from an agent or application and may, in some embodiments, be bound to a principal that may include a user identity, a group or role, and an application context. An MCP management engine 310 consults policy information 312, examples of which are described below. Policy information 312 may reflect a machine-readable corpus that the system 100 maintains and optionally versions. In some embodiments it includes a curated registry that lists approved MCP servers and their tools together with version identifiers and declared input schemas. The registry may include an allowlist and deny-list which approves or denies particular MCP servers or tools. Policy information 312 may further include non-entitlement controls that condition how eligible tools may be used. These controls specify schema constraints, least-privilege directives for optional fields, role-based access control rules, prompt-injection thresholds, sensitive-data redaction rules, and limits for tokens, calls, or token budgets. Substitution mappings and virtual-tool definitions may also be stored in policy information 312 so that an invocation can be rewritten to an approved equivalent when appropriate.

Thus, as an example, the engine 310 may analyze the client request 302 to determine whether an identified tool or associated MCP server is in the allowlist or denylist. The engine 310 may reject the request 302 and optionally transmit back to the agent or client information indicating that the request 302 includes a tool on the denylist. The engine 310 may optionally swap a denied tool with a tool of similar functionality on the allowlist, and then transmit the request 302 along to the allowed tool. The engine 310 may validate that schemas associated with particular tools are formatted properly, and may update the request 302 to utilize a proper schema. Furthermore, access controls may be enforced such that data being surfaced or included in the request 302 is approved for the user or agent making the request 302.

In some embodiments, the MCP management engine 310 may use policy information 312 to control discovery and then to control execution. For discovery, when a client requests a tool catalog, the engine 310 identifies the requesting principal and derives a filtered, version-pinned tool list from the curated registry such that only tools the principal is entitled to plan against are returned. For execution, when a client request 302 addresses a particular server and tool, the engine 310 consults the allowlist and deny-list to determine eligibility for that principal and environment. If eligible, the engine applies the constraints and configurations in policy information 312 to the concrete invocation: arguments are checked against the declared schema and shaped to comply with field-level rules; free-form fields are evaluated for injection risk under the configured prompt-security settings; sensitive content is redacted under the configured data-protection rules. If a policy requires substitution or a virtual tool, the engine adapts the invocation accordingly; if a policy prohibits the call, the engine returns a structured policy outcome rather than forwarding.

Prompt-injection protection may be configured and enforced from policy information 312. In some embodiments, the engine 310 scopes detection to the specific tool and argument fields that can carry instructions, and applies a layered detector defined in policy. The detector can include deterministic patterns (for example, attempts to override tool instructions, requests to disable policy, or encoded indirections), structural checks tied to the advertised schema, and, where configured, a classifier or machine learning model may emit a calibrated risk score conditioned on tool and field context. Policy defines the thresholds and the action taken when a threshold is met, such as blocking the invocation, requiring elevated approval, or proceeding with additional constraints. Detector findings are recorded with the tool name, argument field, and policy version so that enforcement is explainable.

Data redaction may likewise be driven by policy information 312 and applied to caller-supplied arguments before any tool runs. In some embodiments, the engine identifies sensitive categories (e.g., personally identifiable information, protected health or financial identifiers, secrets, and source-code fragments) using deterministic recognizers and named-entity models selected in the policy. Policy information 312 may further specify how to treat each category, including masking strategies and vault-backed tokenization when downstream execution requires a placeholder. Redaction can be targeted to specific fields in a tool's schema or to any free-form field; a redaction map is retained with the request record so that authorized sinks may rehydrate tokens under separate permission if required. If a required redaction would make the invocation non-conformant to the schema, policy may either deny the call or require a different role or tool path.

With these controls in place, policy information 312 provides the inputs the MCP management engine 310 needs to decide what tools an agent may see, what tools it may call, what arguments may be sent, and what protections apply to those arguments. The result is that requests are admitted, adapted, or refused according to authored enterprise policy, rather than by the ad hoc behavior of individual MCP servers.

The policy information 312 in the illustrated example includes a virtual tool. In some embodiments, the engine 310 exposes a virtual tool that presents an enterprise-defined name and schema for a capability while internally routing to an approved backend. The client calls the virtual tool as though it were a server tool; the engine enforces access control, validates and shapes the arguments against the enterprise schema, and adapts the request to the selected backend tool's schema before dispatch. Results are adapted back to the enterprise schema prior to return. This facade decouples client behavior from vendor-specific tools and allows operators to rotate backends, pin versions, or perform per-tenant routing by editing policy information 312 without retraining planners or modifying agent code. Where a direct tool is disallowed but a mapped alternative exists, the engine 310 may apply a deterministic transform that rewrites the invocation to the approved tool and mark the transaction as substituted in the audit record; if compatibility cannot be proven, the engine fails closed and returns a policy outcome that identifies approved alternatives.

In some embodiments, interactions mediated by the engine 310 are observable and auditable. The system 100 may, as an example, do one or more of assign a correlation identifier at ingress, record the principal, the registry versions consulted, the rules and detectors applied, any transformations or redactions performed, quota state at the time of decision, and the identity of the MCP server and tool actually called. Streaming results may be scanned on the return path, and any redactions or cancellations are recorded with span boundaries so that investigators can reconstruct why enforcement occurred. Because all MCP traffic for agents 110A-110N may pass through the same boundary, these records form a single governance plane that provides the functional equivalent of an API gateway for MCP: only approved tools are exposed, safeguards are applied before tool execution, and complete lineage is available for compliance review. The records or other information may be included in a user interface, such as user interface 104.

FIG. 3B illustrates detail of the AI guardrail system 100 receiving a tool request associated with MCP server(s) 320A-320N. In response to a tool request 302 (e.g., an MCP tools/list invocation), the MCP management engine 310 identifies the requesting principal and consults policy information 312 to derive a curated catalog. The catalog may be returned as tool list 304 and include only those MCP servers 320A-320N and tools 322A-322N that are approved for the principal and environment.

In some embodiments, each entry is returned with a version identifier and schema digest so that planning is performed against version-pinned definitions; entries that are deny-listed or not bound to the principal are omitted. In further embodiments, the tool list may include enterprise-defined virtual tools recorded in policy information 312, which present stable capability names and schemas while the system internally routes to approved backends. The engine 310 may generate the catalog from the curated registry or may combine server-reported inventories with registry filters. In either case, execution of any subsequently selected tool may be re-authorized at call time to maintain alignment between discovery and enforcement.

FIG. 3C illustrates detail of the AI guardrail system outputting an analyzed client request based on MCP policy information. As described herein, a client may issue request 302 identifying a server and a named tool together with arguments. The MCP management engine 310 consults policy information 312 to determine eligibility under allowlist and deny-list entries, and applies the configured controls for schema compliance, prompt-injection protection, and sensitive-data redaction. As a few examples, when policy authorizes the call, the engine either originates a new MCP request to an approved MCP server 320A-320N or forwards a shaped request to that server; when policy prohibits the call, the engine returns a structured policy outcome as response 304. In some embodiments, policy information 312 further defines virtual tools and substitution mappings; where applicable, the engine adapts arguments to an approved backend schema and records the adaptation. Results received from the MCP server are optionally evaluated under return-path policy and then included in response 304, together with identifiers that allow the decision, any redactions, and any substitutions to be audited.

### Example Governance Information/Token Quotas

In some embodiments, system 100 implements a centralized governance layer that spans heterogeneous AI interaction modalities. System 100 includes a policy engine (e.g., engine 210) that evaluates machine-readable policies and a set of modality interfaces that normalize events from prompts, model responses, retrieval-augmented generation pipelines, MCP tool calls, and browser-based AI interactions into a common decision format. Policies may be versioned objects that specify scope (e.g., user, group, agent, project, or tenant), conditions (e.g., model family, tool identity, data classification, or request metadata), and actions (e.g., allow, block, redact or tokenize specified fields, substitute an approved capability, or require human review). An administrator or user may author and publish policies through an administrative interface; system 100 distributes active versions to enforcement points and caches them for low-latency use.

In operation, the policy engine may apply the same security, compliance, and trust rules across all modalities. For natural-language prompts, the engine evaluates input constraints, runs prompt-injection protections on fields designated as free-form text, and removes or tokenizes sensitive values identified by detectors configured for personally identifiable information, health or financial identifiers, secrets, or source code. For model responses, the engine verifies content prior to release by applying configured checks such as factuality verification against retrieved context, hallucination risk scoring, toxicity and bias screening, and provenance requirements; unsupported spans are redacted or withheld according to policy. For retrieval-augmented generation, the engine binds the request to a principal, filters candidate passages to those the principal is entitled to access under role-based access control or access-control lists, and constructs an enriched prompt only from authorized, policy-conformant passages with citations. For MCP tool calls, the engine authorizes the addressed server and tool against an allowlist and deny list, validates arguments against a version-pinned schema, applies redaction and injection protections to arguments prior to dispatch, and, where configured, substitutes a virtual tool that presents an enterprise-stable schema while routing to an approved backend. For browser-based AI interactions, a client-side or network-side component mediates submission of prompts and display of model outputs in third-party web applications, applying the same policy decisions and reporting usage to system 100.

In some embodiments, enforcement occurs in real time. The modality interfaces deliver each interaction to the policy engine synchronously; the engine evaluates the applicable policies and returns a disposition that the interface applies before the interaction leaves a trusted boundary or is presented to a user. Streaming responses are scanned incrementally, with the ability to redact spans or terminate the stream when a rule is triggered. Budget and quota checks are performed against per-principal counters so that token use, tool invocations, and external calls remain within configured limits. When a policy requires human approval, the interface pauses the interaction and resumes only after an approval event is received.

In some embodiments, system 100 generates a unified audit log of enforcement actions. Each record carries a correlation identifier, the modality and endpoint involved, the bound principal, the policy version and rules evaluated, the decision reached, any transformations applied (including the fields redacted or tokenized and any substitutions performed), and references to the upstream request and downstream result. For streaming content, span offsets and timing data are recorded so that reviewers can reconstruct which portions were modified or withheld. The audit log is tamper-evident and queryable by project or tenant, enabling compliance reporting and investigation across all modalities without stitching together disparate logs.

This arrangement provides a single governance plane for agentic AI applications. Because the same policy engine and audit substrate are used for prompts, responses, retrieval, tool execution, and browser interactions, administrators define a rule once and rely on consistent behavior wherever the interaction occurs. The result is a concrete improvement to computer security and reliability: authorization and data minimization are applied before network egress or output display, policy outcomes are reproducible across environments, and operational visibility is unified even when models, tools, and user interfaces differ.

In some embodiments, system 100 enforces enterprise token quotas across heterogeneous AI usage. A policy engine maintains a token-budget ledger that associates quotas with principals such as users, groups, agents, applications, and tenants, and with scopes such as project, environment, and time window. Quotas may be defined per interaction type, including prompt submissions, model responses, retrieval operations that prepare prompts, and Model Context Protocol tool calls that invoke models. The ledger stores versioned policies, effective periods, and reset rules, so that a daily, weekly, or rolling-window budget is evaluated consistently at admission time.

In operation, each interaction may, in some embodiments, be admitted after the policy engine performs a real-time token check. A metering component estimates tokens prior to dispatch using the tokenizer of the selected model and, when available, reconciles against the provider-reported token counts on completion. For streaming responses, the system performs reservation and commit: an upper bound is reserved at admission, increments are committed as tokens are generated, and unused reservations are returned to the ledger at termination. If the remaining budget is insufficient, the interaction is refused or downgraded according to policy before any model invocation occurs.

In some embodiments, tokens from different models are normalized so that enforcement is consistent despite provider differences. The metering component applies a normalization map that translates provider-specific token counts into a common unit, optionally weighting prompt and completion tokens differently where policy requires. This allows a single quota to govern interactions that span multiple model families and endpoints without over-or under-counting.

When a quota would be exceeded, system 100 applies control actions defined by policy. Actions include hard block, queue with backoff, or throttle to a configured rate. Where prioritization is enabled, the admission service evaluates a priority associated with the principal or workload and schedules the interaction on a priority queue; lower-priority work may be delayed or dropped to preserve headroom for higher-priority principals. Concurrency limits can cap the number of simultaneous model streams per principal so that a burst from one agent does not starve others.

In some embodiments, the same governance extends to shadow usage. A browser component or network proxy attributes third-party chat interactions to a principal, meters prompt and response tokens locally using the appropriate tokenizer, and submits those measurements to the ledger. The component applies the same admission and throttling decisions at the user interface boundary, thereby preventing quota circumvention when a user interacts with external web-based model interfaces.

System 100 records a unified audit trail for quota enforcement. For each interaction the system writes the bound principal, the budget keys evaluated, the reservation and commit events, the token totals for prompt and response, and the action taken when a threshold was reached. These records provide lineage for budgeting decisions and enable reproducible analysis of how token limits were applied across users, agents, chatbots, and other applications.

### Example Flowcharts

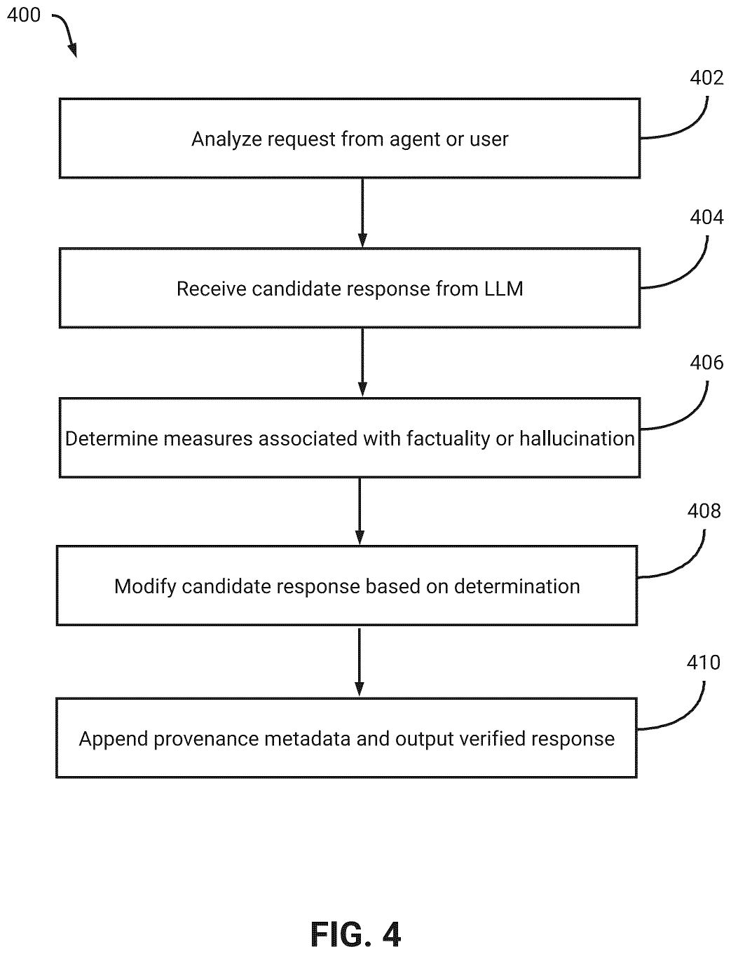

FIG. 4 is a flowchart of an example process 400 for response verification with provenance information. For convenience, the process 400 will be described as being performed by a system of one or more processors (e.g., the AI guardrail system 100).

At block 402, the system analyzes a request received from an agent or a user. As described herein, the system may analyze the request to determine conformance with MCP usage, confidentiality, data access rights and so on.

At block 404, the system receives a candidate response from an LLM. The candidate response may be in response to the request from the agent or user.

At block 406, the system determines one or more measures associated with factuality and hallucination. The measures may indicate whether the response is supported by available context, such as via a RAG or other techniques, and whether unsupported or fabricated content is present. In some embodiments, the system segments the candidate response into claims or spans, compares each span against retrieved enterprise context and, when permitted, external sources, and computes scores such as support similarity, contradiction likelihood, and unanswered-claim indicators. The system may leverage its own LLM as part of this comparison. The system may compute an aggregate signal that summarizes the per-span measurements and classifies the response as accurate, inaccurate, or indeterminate.

At block 408, the system modifies the candidate response based on the determination. Modification can include withholding, redacting, or adjusting text that fails verification, and inserting references for supported statements. In some embodiments, spans that exceed a configured risk threshold are removed or rewritten to align with the supporting passages; indeterminate outcomes route the response for human review; and sensitive information identified by input or output policies is masked or tokenized. For streaming responses, the system may apply these actions incrementally and terminate the stream if a policy threshold is crossed.

At block 410, the system appends provenance, lineage, and confidence information to the candidate response and emits a verified response. Provenance identifies the sources that support the response and anchors each supported statement to a location in those sources. Lineage records how the response was produced, including the request it answers, the retrieval set that informed it, and the policies and components that acted on it. Confidence expresses the system's assessment of support, presented as a score or band for the response as a whole and, where applicable, for individual spans. The result is a response that is not only filtered and corrected, but also accompanied by evidence of origin and a quantified reliability signal.

In some embodiments, citations are interleaved with the text or supplied in an attached envelope that the client can render. Each span of the response is linked to its cited passage and carries a confidence value derived from the verification measures determined at block 406. The lineage record binds the verified response to the originating request and captures any redactions or substitutions performed at block 408, allowing a reviewer to reconstruct the decision path. When confidence falls below a policy threshold, the system may mark the response as provisional or route it for human review before release. Persisting the response together with its provenance, lineage, and confidence enables downstream auditing and repeatable evaluation across runs and environments.

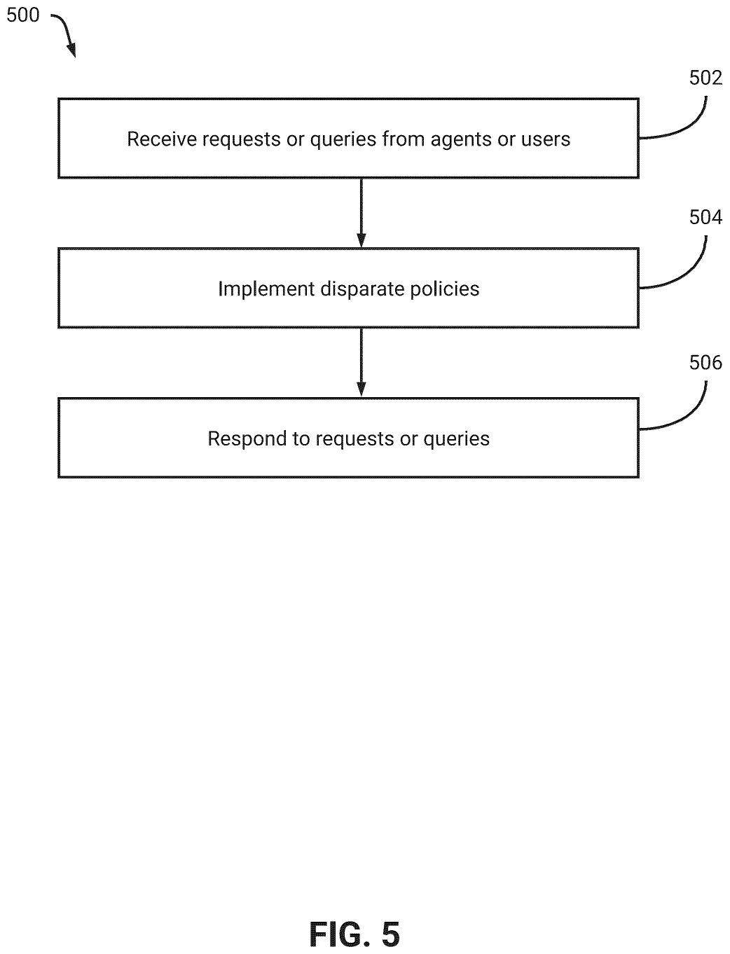

FIG. 5 is a flowchart of an example process 500 for implementing policies associated with generative AI. For convenience, the process 500 will be described as being performed by a system of one or more computers (e.g., the AI guardrail system 100).

At block 502, the system receives requests or queries from agents or users. The system, in some embodiments, intercepts traffic such as API calls, browser submissions, chat prompts, or protocol messages that would invoke or interact with generative AI models. As examples described herein, FIG. 2 illustrates receipt of a query for retrieval-augmented processing, and FIG. 3A-3C illustrate receipt of a client request intended for an MCP server.

At block 504, the system implements disparate policies. Example policies are described herein, for example in FIGS. 1-4. The system may implement these policies, for example to adjust user queries or requests. In some embodiments, the system binds the request to a principal and evaluates applicable policies for the identified modality, including prompt security, response verification prerequisites, data protection, retrieval governance, MCP tool governance, and token budgets. The system may adjust the request or associated context to conform to policy, such as redacting sensitive values, constraining arguments to a declared schema, filtering retrieval candidates to authorized sources, or selecting an approved virtual tool in place of a disallowed tool. Additional examples of applying or leveraging policies are described herein.

At block 506, the system responds to requests or queries. As described above, the system may reject or adjust responses or queries. I n some embodiments, the response reflects the policy outcome: the system may allow and forward an authorized request, may modify the request or its enrichment to meet policy, or may return a structured refusal when policy prohibits the action. By way of example, for MCP interactions the system may route the invocation to an approved server and schema; for model interactions the system may verify factuality and hallucination and emit a verified response with provenance, lineage, and confidence information as described with respect to FIG. 4. In some embodiments, the system records the applied policies and resulting dispositions for auditing.

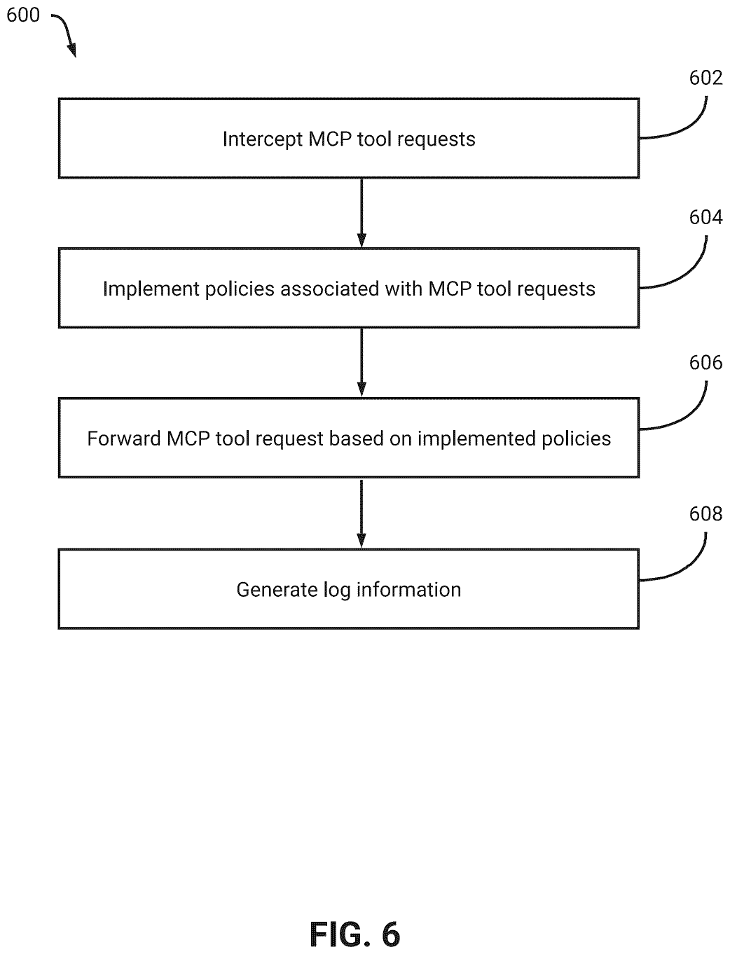

FIG. 6 is a flowchart of an example process 600 for implementing a secure MCP gateway. For convenience, the process 600 will be described as being performed by a system of one or more computers (e.g., the AI guardrail system 100, such as the MCP management engine 310).

At block 602, the system intercepts an MCP tool request issued by an agent or application. The system may optionally associate the request with a principal, which can include a user identity, group or role information, and an application context.

At block 604, the system implements policies associated with MCP tool requests. The system consults policy information (e.g., information 312), which includes a curated registry of approved MCP servers and tools with versioned schemas, allowlist and deny-list entries bound to principals, role-based access rules, prompt-security settings, and data-redaction rules. Using this information, the system determines eligibility of the addressed server and tool, validates arguments against the declared schema, evaluates free-form fields for prompt-injection risk, and redacts or tokenizes sensitive values before any external execution.

At block 606, the system forwards the MCP tool request based on the implemented policies. If policy authorizes the request, the system issues a shaped invocation to an approved MCP server using the validated schema. When policy specifies a virtual tool or substitution mapping, the system adapts the invocation to the selected backend tool and records the adaptation. If policy prohibits the action, the system returns a structured refusal instead of forwarding.

At block 608, the system generates log information for observability and audit. The log records the principal, the policy versions consulted, the server and tool identifiers, the schema version, any redactions or substitutions performed, and the final disposition, together with timestamps and a correlation identifier. Where the response is streamed, the log may include span-level notes indicating redactions or terminations applied on the return path.

### Example Browser or Client Extension

In some embodiments, a browser plug-in or extension may be installed for use by users of an entity. For example, FIG. 1 illustrates a user 112 using a browser extension 114. When a user accesses a browser-based software-as-a-service (SaaS) AI application (e.g., an LLM) via the browser, the browser extension may implement the policies described herein. Similarly, extensions to other clients or applications may be used (e.g., programming applications, integrated development environments, office applications, and so on).

For example, the extension may intercept interactions between a webpage that hosts an AI chat or agent and the remote model endpoint, applies the same prompt-security, sensitive-data protection, and response-verification policies described herein, and reports enforcement outcomes for observability. The extension attributes each interaction to an enterprise principal by obtaining a signed session token from system 100 or an identity provider and attaches that attribution to all subsequent events.

In operation, the extension observes input elements used to compose prompts and captures candidate prompts prior to submission. The extension evaluates the prompt against policies that include redaction of sensitive values, detection of prompt-injection or policy-subversion attempts, and token-budget admission. When a violation is detected, the extension blocks submission or rewrites the prompt to an approved form and presents an in-page notice explaining the action. If permitted by policy, the extension requests additional guidance from system 100, which may return field-level redaction instructions or an approved template that the extension applies locally.

On the output path, the extension intercepts responses rendered by the page, including streamed tokens delivered over example technologies (e.g., XMLHttpRequest, Fetch, Server-Sent Events, or WebSockets). The extension evaluates the emerging text under configured response policies, such as hallucination and factuality checks using retrieved context supplied by system 100, toxicity and bias screening, and provenance requirements when citations are present. The extension may redact spans, annotate supported statements with citations, or halt rendering when thresholds are exceeded. Where policy requires confidence indicators, the extension overlays a reliability badge or per-span confidence ribbon derived from verification measures.

To mitigate shadow AI usage (e.g., in SaaS environments), the extension enforces an enterprise allowlist and deny list of domains and page selectors associated with AI interfaces. When a user navigates to a disallowed interface, the extension prevents prompt entry or network submission and may offer an approved alternative. When a domain is allowed, interaction still proceeds under the same policies, so prompts and responses are governed in situ without requiring changes to the third-party application.

The extension generates observability records for each governed interaction. A record includes the bound principal, the page origin (e.g., SaaS page origin), the policy version, the actions taken (for example, block, redact, substitute, annotate), token counts observed for prompt and response, and references to any supporting sources used for verification. Records are signed and transmitted to system 100; when offline, records are queued in encrypted storage and forwarded when connectivity is restored.

In some embodiments, to enforce token budgets client-side, the extension estimates prompt tokens locally using a tokenizer matched to the selected model and reconciles with provider-reported counts when the page exposes them. Admission can be performed before submission by comparing the estimate to the remaining budget reported by system 100. Concurrency limits can also be enforced by disabling send actions when a user exceeds a configured number of simultaneous streams.

### Example User Interfaces

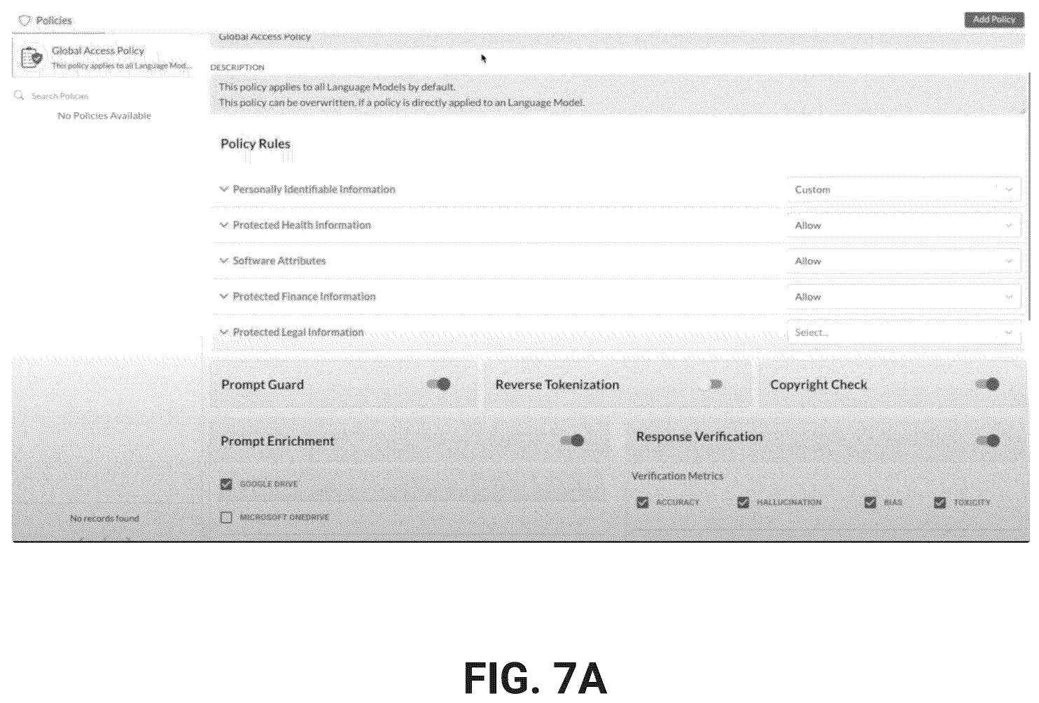

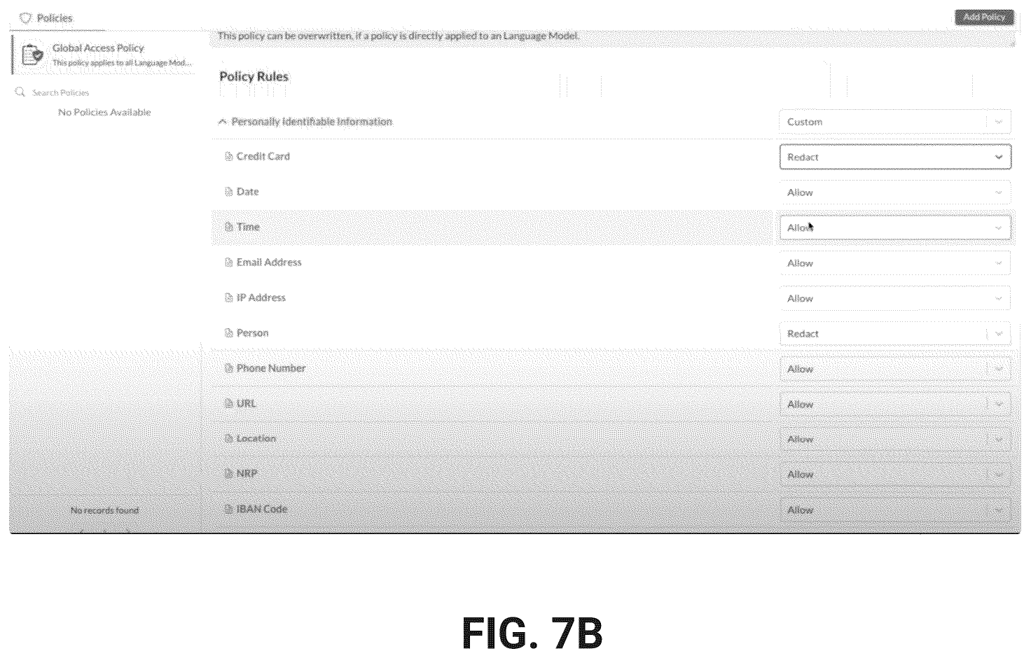

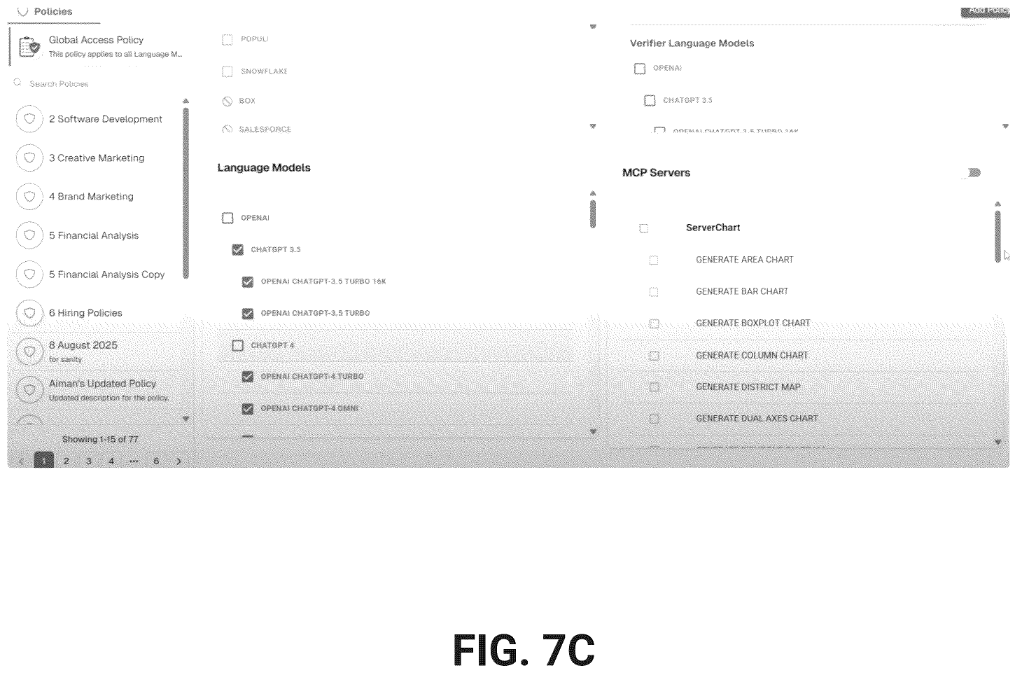

FIGS. 7A-7C illustrate example user interfaces, and may relate to user interface 104 of FIG. 1.

FIG. 7A illustrates an example of implementation of policy rules regarding PII, PHI, software attributes, and so on. As illustrated, the user may have custom rules (e.g., user-defined rules), may allow the type of data, and may reject the data. In the lower portion, specific prompt enrichment sources are indicated as being allowed while others are not allowed. The user can turn on a copyright check to analyze copyright status of output from an LLM. The user can also indicate interest in response verification metrics, such as accuracy, hallucination, bias, toxicity and so on. As described herein, these metrics may form part of metadata which is provided with a response from an LLM.

FIG. 7B illustrates example policy rules reflecting types of information which are allowed, redacted, or have custom rules.

FIG. 7C illustrates example MCP servers which may be approved for use (e.g., an allowlist) or denied.

### Example Embodiments

In some embodiments, a computer-implemented method for secure retrieval-augmented generation (RAG), comprises: receiving a query from a user; retrieving a plurality of candidate documents or document chunks; determining, for each candidate, whether the user has access rights or whether the document is designated as confidential; excluding any non-authorized or confidential candidates from further processing; reranking the remaining candidates; and providing only authorized candidates to a language model for response generation, thereby preventing retrieval of data for which the user lacks authorization. Documents marked confidential are automatically excluded from retrieval unless the user has explicit clearance. Unauthorized chunks are excluded prior to embedding vector search, reranking, or scoring. Metadata filters are applied inline to enforce security classifications, sensitivity tags, or custom enterprise labels. Exclusion policies prevent shadow inclusion of unauthorized data during multi-document retrieval. Inline exclusion guarantees that hallucination grounding does not incorporate unauthorized sources.

In some embodiments, a system for secure execution of model context protocol (MCP) tool calls, comprises: a proxy server configured to intercept tool invocation requests from an AI agent; a policy engine configured to evaluate each intercepted request against enterprise-defined policies, including authorization, data leakage, and injection attack rules; a dispatcher configured to forward only approved requests to an external MCP tool server; and a logging component configured to record all intercepted requests and enforcement decisions, thereby enabling controlled and auditable MCP tool execution. The proxy enforces different RBAC rules for read-only versus read-write tools. The proxy blocks tool invocations for delete or update operations unless explicitly permitted by user role. The proxy applies dynamic RBAC rules based on contextual attributes including time of access, device type, or network origin. The proxy logs all permitted and denied tool invocations for compliance auditing. The proxy enforces RBAC independently of the MCP server itself, providing an external enforcement layer.

In some embodiments, an enterprise AI governance system comprises: a centralized policy engine configured to enforce policies across a plurality of AI interaction modalities, the modalities including at least: (i) natural language prompts, (ii) model responses, (iii) retrieval-augmented generation pipelines, (iv) model context protocol tool calls, and (v) browser-based AI interactions; wherein the policy engine applies consistent security, compliance, and trust rules across all modalities, and generates a unified audit log of enforcement actions, thereby providing a single governance plane for agentic AI applications. A system comprises a unified governance engine that applies centrally defined policies consistently across multiple AI interaction domains including prompts, responses, tool invocations, model selection, and retrieval-augmented data access. Governance policies include redaction of personally identifiable information (PII). Governance policies include rejection of malicious prompts or prompt injection attempts. Governance policies enforce response validation including hallucination detection, factuality checks, and bias detection. Governance policies determine which models are selectable for inference by specific user roles. Governance policies are enforced through a single policy engine that applies across all governed domains simultaneously.

In some embodiments, a method for verifying AI model responses, comprises: receiving a candidate response generated by a language model; comparing elements of the candidate response to one or more retrieved source documents; determining whether each element is supported by the source documents; modifying the candidate response to exclude any elements not supported; appending provenance metadata identifying supporting sources, lineage information, and a confidence score; and outputting the verified response to a user, thereby ensuring explainability and preventing unverifiable hallucinations. A system comprises a provenance engine that attaches source metadata, lineage identifiers, and confidence scores to enriched responses, thereby providing explainability for AI outputs. Lineage identifiers include the original document identifier and retrieval timestamp. Source metadata includes author, sensitivity level, and enterprise classification labels. Confidence scores are generated based on retrieval relevance scores and model agreement metrics. Provenance data is logged for compliance and made available to end users in the response output. Provenance tracking prevents unverifiable or source-less answers from being surfaced.

In some embodiments, a system for enforcing AI usage quotas and costs, comprises: a monitoring component configured to track tokens consumed and monetary costs incurred by a plurality of AI interactions; a policy engine configured to determine whether a given interaction exceeds a predefined quota or budget threshold; a control component configured to throttle, block, or prioritize interactions based on said determination; and a reporting component configured to log and report usage and enforcement actions, thereby providing cost governance across enterprise AI applications. A system comprises a cost and quota governance engine that applies per-user or per-agent policies to restrict tool calls, API usage, or model inference based on predefined cost budgets or usage quotas. The governance engine enforces cost ceilings in real time to prevent excessive agentic usage. The governance engine applies different quota limits per role, project, or business unit. Quota exhaustion triggers an automated request for elevated limits subject to approval. The governance engine provides per-agent and per-tool usage metering. Cost and quota enforcement is integrated with RBAC such that only authorized users may allocate quota budgets.

In some embodiments, a browser extension for enforcing AI governance policies, the extension comprises: an interception module configured to capture data exchanges between a browser-based AI application and a remote language model; a policy evaluation engine configured to detect violations including prompt injection, sensitive data exposure, or hallucination risks; a control module configured to block, redact, or modify data exchanges responsive to detected violations; and a logging module configured to record enforcement actions, thereby enabling enterprise governance of browser-based AI applications and mitigating shadow AI usage. A system comprises a browser extension that intercepts calls from SaaS-based AI agents or LLM interfaces accessed through a browser, enforces enterprise policies, and prevents unauthorized shadow AI usage. The browser extension enforces PII redaction policies on user prompts prior to transmission. The browser extension blocks unauthorized SaaS-based agents by policy. The browser extension provides observability logs of all browser-based agent interactions. The browser extension enforces prompt security including jailbreak and prompt injection detection. The browser extension integrates with centralized enterprise policy engines to synchronize governance with non-browser agents.

### Other Embodiments

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A method implemented by a system of one or more computers, the system implementing a platform, and the method comprising:
analyzing a user prompt from an end-user associated with an entity, the user prompt being provided to a first generative artificial intelligence (AI) application associated with the platform, and the user prompt being analyzed to enforce policy controls associated with the entity;
enriching the user prompt based on a retrieval augmented generation (RAG) process, wherein the user prompt is enriched based on data stored by, or otherwise accessible to, the entity;
forming metadata associated with the enrichment, the metadata identifying specific data used for enrichment and lineage information reflecting a record of the internal processing path from user prompt to response;
providing a response to the end-user based on the analyzed output.

2. The method of claim 1, wherein the first generative AI application includes one or more tasks.

3. The method of claim 2, wherein the one or more tasks are defined using the platform.

4. The method of claim 2, wherein the first generative AI application is an agentic application.

5. The method of claim 1, wherein the first generative AI application was designed using the platform.

6. The method of claim 1, further comprising analyzing output from a second generative AI application, wherein the output is analyzed based on the policy controls, wherein the second generative AI application is an external generative AI application.

7. The method of claim 6, wherein the external generative AI application is an external large language model (LLM).

8. The method of claim 1, wherein the user prompt and/or output is analyzed to identify one or more of personally identifiable information, protected health information, intellectual property, source code.

9. The method of claim 1, wherein the user prompt and/or output is analyzed to evaluate for jail break or adversarial content.

10. The method of claim 1, wherein the user prompt and/or output is analyzed to for one or more of toxicity, bias, hallucination, copyright, factuality.

11. The method of claim 10, wherein to analyze for hallucination, the method comprises:
providing the enriched user prompt and output as inputs to a verification LLM; and
obtaining a hallucination score.

12. The method of claim 10, wherein to analyze for factuality, the method comprises:
providing the enriched user prompt and output as inputs to a verification LLM; and
comparing the output with the verification LLM output via a vector embedding space comparison.

13. The method of claim 1, wherein the platform enforces user or role-based access controls.

14. The method of claim 1, wherein the platform integrates with one or more identity providers (IdPs).

15. The method of claim 1, wherein the policy controls include role-based access controls.

16. The method of claim 15, wherein the user prompt is enriched based on data authorized for access by the end-user, and wherein the RAG process is performed on a subset of data stored by the entity which is authorized for access by the end-user.

17. The method of claim 1, wherein the policy controls include implementation of access control lists.

18. The method of claim 1, wherein lineage information includes at least a subset of information identifying the end-user, components executed, policies and configurations applied, intermediate artifacts consulted, transformations performed, and timestamps.

19. A system comprising one or more processors and computer storage media storing instructions that when executed by the one or more processors, cause the one or more processors to perform the method of claim 1.

20. Non-transitory computer storage media storing instructions that when executed by a system of one or more processors, cause the one or more processors to perform the method of claim 1.

21. A method implemented by a system of one or more processors, the method comprising:
intercepting, via a gateway implemented by the system, a client request associated with a tool invocation via a model context protocol (MCP) server, wherein the gateway operates as a proxy server between a plurality of MCP servers and a plurality of agents or consoles utilized by end-users;
accessing policy information associated with MCP, the policy information reflecting, at least, an allowlist and a denylist associated with MCP servers and/or tools;
implementing the policy information, wherein implementing includes:
adjusting the client request to replace an MCP server included in the client request with a different MCP server, or
adjusting the client request to update a schema associated with a tool identified in the client request; and
forwarding the client request for receipt by an approved MCP server.

22. The method of claim 21, wherein implementing the policy information comprises:
analyzing, via a classifier, a prompt included in the client request, wherein the prompt is analyzed to detect prompt-injection techniques.

23. The method of claim 21, wherein updating the schema comprises shaping arguments included in the client request based on a particular schema.

24. The method of claim 21, wherein implementing the policy information comprises analyzing virtual tool; information, wherein the client request includes information indicative of a tool, wherein the virtual tool information maps one or more MCP servers to associated tools with functionality similar to the indicated tool, and wherein the client request is updated to include a selection of one of the MCP servers mapped to one of the associated tools.

25. The method of claim 21, wherein to forward the client request the gateway is configured to form a new client request.

26. The method of claim 21, wherein the gateway is configured to provide a list of available tools to agents or consoles.

27. The method of claim 21, wherein implementing the policy information includes redacting personally identifiable information, protected-health identifiers, secrets, or source-code spans.

28. The method of claim 27, further comprising:
evaluating a result returned from the approved MCP server and redacting information prior to delivering a response in response to the client request.

29. The method of claim 21, further comprising forming audit information that identifies a principal, details regarding implementation of the policy information, and the approved MCP server.

30. The method of claim 21, wherein a second client request is received, and wherein implementing the policy information comprises:
discarding the second client request, and
forming a response describing reasons for rejecting the second client request based on the policy information.

31. A system comprising one or more processors and computer storage media storing instructions that when executed by the one or more processors, cause the one or more processors to perform the method of claim 21.

32. Non-transitory computer storage media storing instructions that when executed by a system of one or more processors, cause the one or more processors to perform the method of claim 21.
